(19) United States
(12) Patent Application Publication
(10) Pub. No.: US 2015/0109562 A1
(43) Pub. Date: Apr. 23, 2015

(54) LIQUID CRYSTAL DISPLAY DEVICE AND ELECTRONIC DEVICE

(71) Applicant: Japan Display Inc., Minato-ku (JP)

(72) Inventors: Masaya TAMAKI, Tokyo (JP); Osamu ISHIGE, Tokyo (JP)

(73) Assignee: Japan Display Inc., Minato-ku (JP)

(21) Appl. No.: 14/507,997

(22) Filed: Oct. 7, 2014

(30) Foreign Application Priority Data
Oct. 21, 2013 (JP) 2013-218346

(51) Int. Cl. G02F 1/1335; G02F 1/13363

(52) U.S. Cl. CPC G02F 1/133528; G02F 1/133553; G02F 1/133514; G02F 1/13363
USPC 349/96

(57) ABSTRACT

According to one embodiment, a liquid crystal display device includes a first polarizing layer, a second polarizing layer, a first substrate unit, a liquid crystal layer, and a second substrate unit. The first substrate unit is provided between the first and second polarizing layers. The first substrate unit includes a first pixel electrode, a second pixel electrode, and an inter-pixel region between the first and second pixel electrodes. The first and second pixel electrodes are light-reflective and disposed in a first major surface intersecting a direction from the first polarizing layer toward the second polarizing layer. The second substrate unit is provided between the first substrate unit and the second polarizing layer. An opposing electrode is provided in a second major surface of the second substrate unit. The opposing electrode is light-transmissive. The liquid crystal layer is provided between the first and second major surfaces.

### CROSS-REFERENCE TO RELATED APPLICATIONS

This application is based upon and claims the benefit of priority from Japanese Patent Application No. 2013-218346, filed on Oct. 21, 2013; the entire contents of which are incorporated herein by reference.

### FIELD

Embodiments described herein relate generally to a liquid crystal display device and an electronic device.

### BACKGROUND

Liquid crystal display devices are used in various applications. The power consumption can be low in a reflection-type display device in which the display is performed using external light. It is necessary to improve the ease of viewing of a reflection-type liquid crystal display device.

### SUMMARY OF THE INVENTION

According to one embodiment, a liquid crystal display device includes a first polarizing layer, a second polarizing layer, a first substrate unit, a liquid crystal layer, and a second substrate unit. The first substrate unit is provided between the first polarizing layer and the second polarizing layer. The first substrate unit includes a first pixel electrode, a second pixel electrode, and an inter-pixel region provided between the first pixel electrode and the second pixel electrode. The first pixel electrode and the second pixel electrode are light-reflective and disposed in a first major surface intersecting a direction from the first polarizing layer toward the second polarizing layer. The second substrate unit is provided between the first substrate unit and the second polarizing layer. An opposing electrode is provided in a second major surface of the second substrate unit. The opposing electrode is light-transmissive. The liquid crystal layer is provided between the first major surface and the second major surface. At least a portion of a first light passing through the second polarizing layer, the liquid crystal layer, and the inter-pixel region is able to be incident on the first polarizing layer.

### BRIEF DESCRIPTION OF THE DRAWINGS

FIG. 1 is a schematic cross-sectional view illustrating a liquid crystal display device according to a first embodiment;

FIG. 2 is a schematic cross-sectional view illustrating another liquid crystal display device according to the first embodiment;

FIG. 3A to FIG. 3C are schematic views illustrating the liquid crystal display device according to the first embodiment;

FIG. 4A to FIG. 4C are graphs illustrating characteristics of the liquid crystal display device according to the first embodiment;

FIG. 5A and FIG. 5B are schematic views illustrating operations of the liquid crystal display device according to the first embodiment;

FIG. 6 is a schematic view illustrating characteristics of the liquid crystal display device according to the first embodiment;

FIG. 7 is a schematic cross-sectional view illustrating a liquid crystal display device according to a second embodiment;

FIG. 8A to FIG. 8D are schematic views illustrating a portion of the liquid crystal display device according to the second embodiment;

FIG. 9A and FIG. 9B are schematic plan views illustrating characteristics of the liquid crystal display device according to the second embodiment;

FIG. 10A to FIG. 10C are schematic cross-sections illustrating characteristics of liquid crystal display devices and electronic devices;

FIG. 11 is a schematic cross-sectional view illustrating another liquid crystal display device according to the second embodiment;

FIG. 12 is a schematic cross-sectional view illustrating another liquid crystal display device according to the second embodiment;

FIG. 13 is a schematic cross-sectional view illustrating a liquid crystal display device according to a third embodiment;

FIG. 14 is a schematic cross-sectional view illustrating other liquid crystal display device according to the third embodiment; and

FIG. 15 is a schematic cross-sectional view illustrating other liquid crystal display device according to the third embodiment.

### DETAILED DESCRIPTION

Embodiments of the invention will now be described with reference to the drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

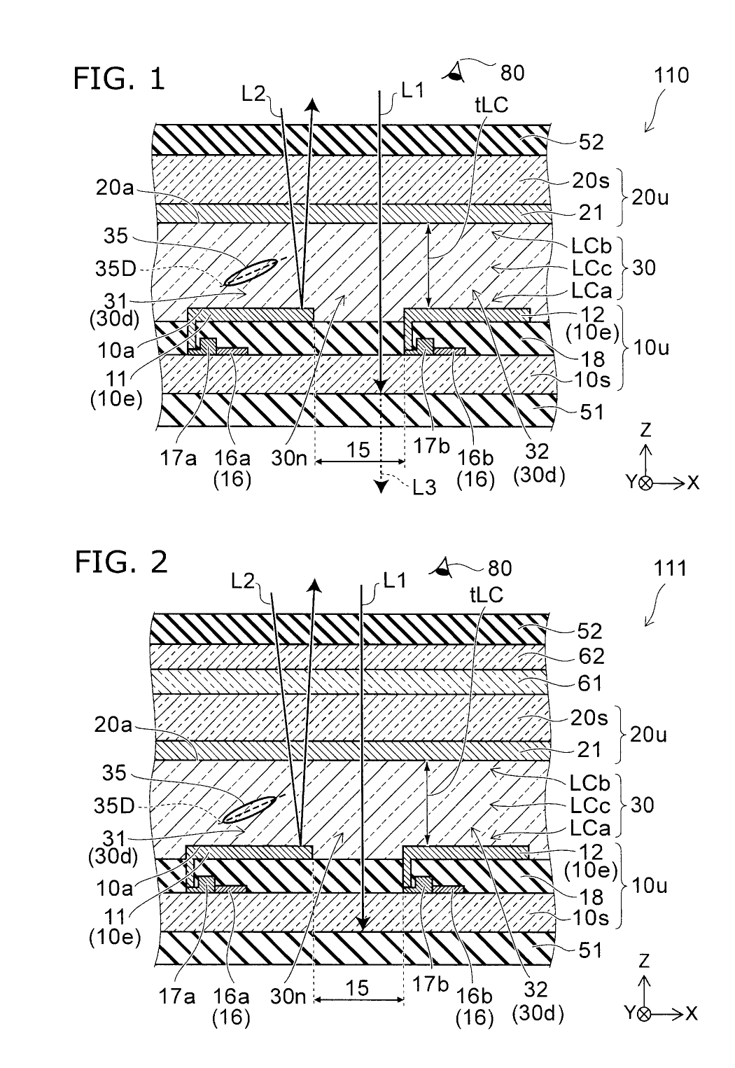

FIG. 1 is a schematic cross-sectional view illustrating a liquid crystal display device according to a first embodiment.

As shown in FIG. 1, the liquid crystal display device 110 according to the embodiment includes a first polarizing layer 51, a second polarizing layer 52, a first substrate unit 10u, a second substrate unit 20u, and a liquid crystal layer 30.

A direction from the first polarizing layer 51 toward the second polarizing layer 52 is taken as a Z-axis direction. One direction perpendicular to the Z-axis direction is taken as an X-axis direction. A direction perpendicular to the Z-axis direction and the X-axis direction is taken as a Y-axis direction.

The first polarizing layer 51 and the second polarizing layer 52 extend along, for example, the X-Y plane.

The first substrate unit 10u is provided between the first polarizing layer 51 and the second polarizing layer 52. The first substrate unit 10u has a first major surface 10a. The first major surface 10a intersects the Z-axis direction. In the example, the first major surface 10a is parallel to the X-Y plane. The first substrate unit 10u includes multiple pixel electrodes 10e (e.g., a first pixel electrode 11, a second pixel electrode 12, etc.). The multiple pixel electrodes 10e are disposed inside the first major surface 10a. The multiple pixel electrodes 10e are light-reflective.

The first substrate unit 10u includes an inter-pixel region 15. The inter-pixel region 15 is a region between the first pixel electrode 11 and the second pixel electrode 12. The inter-pixel region 15 is a region between the multiple pixel electrodes 10e.

The second substrate unit 20u is provided between the first substrate unit 10u and the second polarizing layer 52. The second substrate unit 20u has a second major surface 20a. The second major surface 20a opposes, for example, the first major surface 10a. The second substrate unit 20u includes an opposing electrode 21 (a common electrode). The opposing electrode 21 is provided on the second major surface 20a. The opposing electrode 21 is light-transmissive.

The liquid crystal layer 30 is provided between the first major surface 10a and the second major surface 20a. A portion of the liquid crystal layer 30 is disposed between the opposing electrode 21 and the multiple pixel electrodes 10e. Another portion of the liquid crystal layer 30 is disposed between the opposing electrode 21 and the inter-pixel region 15 of the first substrate unit 10u.

The liquid crystal layer 30 includes pixel units 30d (e.g., a first pixel unit 31, a second pixel unit 32, etc.). The first pixel unit 31 is disposed between the first pixel electrode 11 and the second substrate unit 20u. The second pixel unit 32 is disposed between the second pixel electrode 12 and the second substrate unit 20u. The liquid crystal layer 30 further includes a non-pixel portion 30n. The non-pixel portion 30n is disposed between the inter-pixel region 15 and the second substrate unit 20u.

The liquid crystal layer 30 includes, for example, a nematic liquid crystal. A liquid crystal 35 that is included in the liquid crystal layer 30 has a long-axis direction 35D (a director). The long-axis direction 35D of the liquid crystal 35 changes according to a voltage applied to the liquid crystal layer 30. In other words, the liquid crystal alignment of the liquid crystal layer 30 changes according to the voltage. For example, the effective birefringence (the retardation) of the liquid crystal layer 30 changes according to the change of the liquid crystal alignment. The change of the effective birefringence is converted into the brightness of the light by polarizing layers. Thereby, a display is performed. The optical rotatory properties (the optical activity) may change according to the change of the liquid crystal alignment.

In the liquid crystal display device 110, a viewer 80 views the display of the liquid crystal display device 110 from the second polarizing layer 52 side. The second polarizing layer 52 is disposed between the viewer 80 and the first polarizing layer 51. The second polarizing layer 52 side corresponds to the front side. The first polarizing layer 51 side corresponds to the backside. The liquid crystal display device 110 is, for example, a reflection-type display device.

Light (a second light L2) that is incident on the liquid crystal display device 110 from the front side passes through the second polarizing layer 52, the second substrate unit 20u, and the liquid crystal layer 30 and is incident on the pixel electrode 10e (e.g., the first pixel electrode 11). The second light L2 that is incident on the pixel electrode 10e is reflected at the pixel electrode 10e. The second light L2 that is reflected passes through the liquid crystal layer 30, the second substrate unit 20u, and the second polarizing layer 52 and is emitted to the outside from the front side.

According to the voltage applied to the liquid crystal layer 30, the liquid crystal alignment of the pixel unit 30d (e.g., the first pixel unit 31) changes; and the optical characteristics (e.g., the effective birefringence, e.g., the retardation) of the pixel unit 30d change. According to the change of the optical characteristics, the brightness of the second light L2 passing through the second polarizing layer 52 to be emitted to the outside changes. The brightness at the pixel unit 30d changes according to the voltage; and the display is performed.

For example, in the state in which the voltage is not applied, the pixel unit 30d is in a bright state. In the state in which a prescribed voltage is applied, the pixel unit 30d is in a dark state. For example, in the case where the liquid crystal layer 30 has a threshold, the prescribed voltage is a voltage that is higher than (has an effective value greater than) the threshold. For example, a normally bright (e.g., a normally white) configuration is applied to the pixel unit 30d. As described below, a normally dark (e.g., a normally black) configuration is applicable to the pixel unit 30d.

On the other hand, light (a first light L1) that passes through the non-pixel portion 30n can be incident on the first polarizing layer 51. For example, at least a portion of the first light L1 that passes through the second polarizing layer 52, the liquid crystal layer 30 (the non-pixel portion 30n), and the inter-pixel region 15 can be incident on the first polarizing layer 51. At least a portion of the light (the first light L1) passing through the non-pixel portion 30n is substantially absorbed by the first polarizing layer 51. In other words, the intensity of light (a third light L3) produced when the first light L1 passes through the first polarizing layer 51 is extremely low. In the non-pixel portion 30n (the inter-pixel region 15), for example, a voltage substantially is not applied to the liquid crystal layer 30. In other words, in the non-pixel portion 30n, the liquid crystal alignment is an initial alignment. In the initial alignment, the dark state is formed. In other words, a normally dark (a normally black) configuration is employed.

A good dark state is formed in the inter-pixel region 15 by the first light L1 passing through the inter-pixel region 15 and being absorbed by the first polarizing layer 51. Thereby, light from the backside (the image of an object disposed on the backside) substantially does not pass through to the front side. Thereby, an easily-viewable display is possible. As described below, for example, an oblique electric field (an electric field having a component tilted with respect to the Z-axis direction) that occurs due to the multiple pixel electrodes 10e may be applied to the non-pixel portion 30n. Thereby, in the non-pixel portion 30n, the liquid crystal alignment may change according to the voltage applied to the pixel electrodes 10e. In the embodiment, the change of the liquid crystal alignment of the non-pixel portion 30n may be, for example, smaller than the change of the liquid crystal alignment at the pixel unit 30d. The effect of the change of the liquid crystal alignment of the non-pixel portion 30n on the display may be ignored.

In the example, the second substrate unit 20u further includes a second substrate 20s. The second substrate 20s is light-transmissive. The opposing electrode 21 is disposed between the second substrate 20s and the liquid crystal layer 30.

On the other hand, the first substrate unit 10u further includes a first substrate 10s, interconnects 16 (a first interconnect 16a, a second interconnect 16b, etc.), a first switching element 17a, a second switching element 17b, and an insulating layer 18.

The first substrate 10s is provided between the first polarizing layer 51 and the liquid crystal layer 30. The first substrate 10s is light-transmissive.

The first switching element 17a (e.g., a transistor, a nonlinear resistance element, etc.) is electrically connected to the first pixel electrode 11. The first interconnect 16a is electrically connected to the first switching element 17a. For example, the first interconnect 16a is a signal line. For example, the signal line supplies charge to the first pixel electrode 11. The supply of the charge is performed via the first switching element 17a. Or, the first interconnect 16a may be a scanning line (a gate line). A signal that controls the operation of the first switching element 17a is input to the scanning line.

The second switching element 17b (e.g., a transistor, a nonlinear resistance element, etc.) is electrically connected to the second pixel electrode 12. The second interconnect 16b is electrically connected to the second switching element 17b. For example, the second interconnect 16b is, for example, a signal line or a scanning line (a gate line).

The insulating layer 18 is provided between the first interconnect 16a and the first pixel electrode 11. The insulating layer 18 is further provided between the second interconnect 16b and the second pixel electrode 12.

At least a portion of the first interconnect 16a is positioned between the first pixel electrode 11 and the first polarizing layer 51. At least a portion of the second interconnect 16b is positioned between the second pixel electrode 12 and the first polarizing layer 51.

At the first substrate unit 10u, the interconnects 16 (and the switching elements) are covered with the insulating layer 18. The pixel electrodes 10e are provided on the insulating layer 18. The interconnects 16 are insulated from the pixel electrodes 10e by the insulating layer 18. Thereby, the surface area ratio of the pixel electrodes 10e can be increased. Thereby, the brightness of the display can be increased. A high contrast ratio is obtained.

For example, there is a first reference example in which, for example, an interconnect layer or the like is disposed as a light-shielding layer in the inter-pixel region 15 of the first substrate unit 10u. In such a first reference example, the image that is on the backside is not viewed because the light from the backside is shielded by the interconnect layer. However, in the first reference example, for example, the contrast ratio decreases due to reflections at the interconnect layer. For example, the first light L1 passes through the second polarizing layer 52, the non-pixel portion 30n, and the inter-pixel region 15 and is incident on the interconnect layer. The light that is incident on the interconnect layer is reflected at the interconnect layer and travels toward the second polarizing layer 52. The contrast ratio decreases due to this reflection.

On the other hand, there is a second reference example in which a light-shielding layer (a black matrix) corresponding to the inter-pixel region 15 is provided in the second substrate unit 20u. In the second reference example as well, the image that is on the backside is not viewed. However, in the second reference example, the surface area ratio of the pixel electrodes 10e decreases when the resolution is increased and the pitch of the pixels is reduced because there is a limit to how much the positional precision of the light-shielding layer can be increased. Therefore, it is difficult to sufficiently increase the brightness.

In the embodiment, the light (the first light L1) that passes through the inter-pixel region 15 is absorbed by the first polarizing layer 51. Thereby, the image that is on the backside substantially is not viewed. Also, the first light L1 that is reflected by the interconnect layer, etc., to travel toward the second polarizing layer 52 is substantially suppressed. In the embodiment, a light-shielding layer (a black matrix), etc., may not be provided in the second substrate unit 20u. Therefore, in the case where the resolution is high, a high surface area ratio of the pixel electrodes 10e can be maintained.

In the embodiment as described below, a light-shielding layer may be further provided in the second substrate unit 20u. In the example, because the first light L1 that passes through the inter-pixel region 15 is absorbed by the first polarizing layer 51, the requirements of the positional precision and optical characteristics (light-absorbing properties) of the light-shielding layer provided in the second substrate unit 20u are relaxed.

In the embodiment, the light (the first light L1, the second light L2, etc.) includes visible light. The wavelength of visible light is, for example, not less than 380 nanometers (nm) and not more than 700 nm. In the following description, the characteristics are described for the case where the wavelength of the light is 550 nm for ease of description. The following description also is applicable to light of wavelengths other than visible light.

In the embodiment, the first substrate 10s and the second substrate 20s include glass substrates or resin substrates.

The opposing electrode 21 includes, for example, a conductive material that is light-transmissive. The opposing electrode 21 includes, for example, an oxide including at least one element selected from the group consisting of In, Sn, Zn, and Ti. The opposing electrode 21 includes, for example, ITO (Indium Tin Oxide), etc. The opposing electrode 21 may include, for example, a thin metal layer that is light-transmissive.

The opposing electrode 21 is light-transmissive. For the members (the first substrate 10s, the second substrate 20s, the opposing electrode 21, etc.) that are light-transmissive, the transmittance is higher than the reflectance. For the members that are light-transmissive, the transmittance is higher than the absorptance.

The pixel electrodes 10e include, for example, aluminum, etc. The pixel electrodes 10e are light-reflective. For the members (the pixel electrodes 10e, etc.) that are light-reflective, the reflectance is higher than the transmittance. For the members that are light-reflective, for example, the reflectance is higher than the absorptance.

For example, it is favorable for the pixel electrodes 10e (the first pixel electrode 11, the second pixel electrode 12, etc.) to have specular reflectivity. For example, the polarization characteristics of the light that is incident on and reflected by the pixel electrodes 10e substantially are not changed by the reflection. For example, in the case where the pixel electrodes 10e have high diffuse reflectivity, the polarization characteristics of the reflected light may be different from the polarization characteristics of the incident light. For example, the contrast ratio of the display may decrease in the case where the polarities degrade due to the reflection. In the case where the pixel electrodes 10e have specular reflectivity, it is easy to obtain a high contrast ratio.

The front surfaces of the pixel electrodes 10e are relatively flat. Thereby, specular reflectivity is obtained easily.

The first substrate unit 10u and the second substrate unit 20u may further include alignment films (not shown). For example, the alignment films cover the pixel electrodes 10e and the opposing electrode 21. The alignment films align the liquid crystal of the liquid crystal layer 30. The alignment films include, for example, organic films such as polyimide, etc. The alignment of the liquid crystal layer 30 is determined by the characteristics of the alignment films (e.g., the anisotropy). For example, rubbing is performed on the alignment films. Anisotropy may be provided in the alignment films by, for example, photo-alignment processing, etc.

The liquid crystal layer 30 includes, for example, a nematic liquid crystal. The liquid crystal layer 30 may include a chiral agent. A thickness tLC of the liquid crystal layer 30 is, for example, the distance along the Z-axis direction between the alignment film covering the pixel electrodes 10e and the alignment film covering the opposing electrode 21.

The liquid crystal layer 30 includes a first portion LCa, a second portion LCb, and a third portion LCc. The second portion LCb is disposed between the opposing electrode 21 and the first portion LCa. The third portion LCc is disposed between the first portion LCa and the second portion LCb. The first portion LCa is the portion of the liquid crystal layer 30 on the first substrate unit 10u side. The second portion LCb is the portion of the liquid crystal layer 30 on the second substrate unit 20u side. The third portion LCc is the central portion.

For example, the dielectric anisotropy of the liquid crystal layer 30 may be positive or negative. Hereinbelow, an example is described in which the dielectric anisotropy of the liquid crystal layer 30 is positive for ease of description.

For example, when a voltage is not applied to the liquid crystal layer 30 (the initial state), the long-axis direction 35D of the liquid crystal 35 of the liquid crystal layer 30 is substantially along the X-Y plane. For example, the pretilt angle (the angle between the long-axis direction 35D and the X-Y plane) of the liquid crystal 35 is 10 degrees or less, e.g., about 5 degrees. When the voltage is applied to the liquid crystal layer 30, the tilt angle of the liquid crystal becomes large. When applying the voltage, for example, the tilt angle is about 90 degrees at the third portion LCc of the liquid crystal layer 30. When the dielectric anisotropy of the liquid crystal layer 30 is negative, the pretilt angle is, for example, not less than 70 degrees and not more than 90 degrees. The pretilt angle is arbitrary in the embodiment.

At the first portion LCa, the alignment direction (the long-axis direction 35D (the liquid crystal director direction)) of the liquid crystal is determined by, for example, the alignment processing direction (e.g., the rubbing direction) of the alignment film of the first substrate unit 10u. At the second portion LCb, the alignment processing direction (the long-axis direction 35D (the liquid crystal director direction)) of the liquid crystal is determined by, for example, the alignment direction (e.g., the rubbing direction) of the alignment film of the second substrate unit 20u.

For example, information relating to the alignment processing direction (e.g., the rubbing direction) of the alignment film is obtained by analyzing the alignment film using polarized light. For example, information relating to the alignment processing direction of the alignment film is obtained by observing the nonuniformity (e.g., rubbing scratches, etc.) of the alignment processing. There are cases where lines based on the nonuniformity of the alignment processing are easy to view when, for example, a voltage including direct current is applied between the opposing electrode 21 and the pixel electrodes 10e. The alignment processing direction (and the long-axis direction 35D) can be determined based on the lines.

For example, the alignment direction (the long-axis direction 35D) of the liquid crystal at the first portion LCa is determined by determining the alignment processing direction of the first substrate unit 10u. The alignment direction of the liquid crystal at the first portion LCa is aligned with the alignment processing direction of the first substrate unit 10u. Similarly, for example, the alignment direction (the long-axis direction 35D) of the liquid crystal at the second portion LCb is determined by determining the alignment processing direction of the second substrate unit 20u. In other words, the alignment direction of the liquid crystal at the second portion LCb is aligned with the alignment processing direction of the second substrate unit 20u.

The interconnects 16 (the first interconnect 16a and the second interconnect 16b) that are provided in the first substrate unit 10u include, for example, metal films.

The semiconductor layer that is included in the first switching element 17a and the second switching element 17b includes, for example, polysilicon, amorphous silicon, or an oxide semiconductor. The oxide semiconductor includes, for example, an oxide including at least one selected from indium (In), gallium (Ga), and zinc (Zn).

The insulating layer 18 may include, for example, a resin material. For example, at least one selected from an acrylic resin and a polyimide resin is used as the resin material. The insulating layer 18 may be light-absorbing. Thereby, the transmission of the light in the inter-pixel region 15 is suppressed. On the other hand, in the case where the light-transmissivity of the insulating layer 18 is high, high patterning precision of the insulating layer 18 is obtained easily. The insulating layer 18 may include a stacked film of a resin layer and an inorganic layer. For example, at least one selected from silicon nitride, silicon oxynitride, and silicon oxide is used as the inorganic layer.

The first polarizing layer 51 and the second polarizing layer 52 include polarizing films, polarizing plates, etc. For example, the first polarizing layer 51 and the second polarizing layer 52 may include adhesive layers. The first polarizing layer 51 is fixed to the first substrate unit 10u by the adhesive layer. The second polarizing layer 52 is fixed to the second substrate unit 20u by the adhesive layer.

FIG. 2 is a schematic cross-sectional view illustrating another liquid crystal display device according to the first embodiment.

As shown in FIG. 2, a first phase difference layer 61 and a second phase difference layer 62 are further provided in the liquid crystal display device 111 according to the embodiment. Otherwise, the liquid crystal display device 111 is similar to the liquid crystal display device 110; and a description is therefore omitted.

The first phase difference layer 61 is disposed between the liquid crystal layer 30 and the second polarizing layer 52. In the example, the first phase difference layer 61 is disposed between the second substrate 20s and the second polarizing layer 52. The second phase difference layer 62 is disposed between the liquid crystal layer 30 and the second polarizing layer 52. In the example, the second phase difference layer 62 is disposed between the first phase difference layer 61 and the second polarizing layer 52. The first phase difference layer 61 and the second phase difference layer 62 may be considered to be a portion of the second substrate unit 20u. The first phase difference layer 61, the second phase difference layer 62, and the second substrate unit 20u may be separate entities.

For example, a quarter-wave plate is used as the first phase difference layer 61. The retardation of the first phase difference layer 61 is, for example, not less than 100 nanometers and not more than 150 nanometers.

For example, a half-wave plate is used as the second phase difference layer 62. The retardation of the second phase difference layer 62 is, for example, not less than 240 nanometers and not more than 290 nanometers.

For example, the first phase difference layer 61 and the second phase difference layer 62 include stretched films, etc. For the phase difference layers, the product of the birefringence of the phase difference layer and the thickness of the phase difference layer corresponds to the retardation. The retardation can be determined by analysis using polarized light.

For example, the first phase difference layer 61 substantially changes the linearly polarized light that is incident into circularly polarized light. For example, the second phase difference layer 62 changes the polarization direction of the linearly polarized light that is incident 90 degrees.

By using these phase difference layers, the change of the optical characteristics (e.g., the effective birefringence) of the liquid crystal layer 30 can be efficiently changed into a change of the brightness of the light. In other words, the brightness is increased; and a high contrast ratio is obtained. The wavelength dependence becomes small.

In the embodiment, these phase difference layers may be provided as necessary and may be omitted. By using the first phase difference layer 61, for example, a high brightness and a high contrast ratio are obtained easily. By using the second phase difference layer 62, for example, the wavelength dependence of the optical characteristics is improved, e.g., coloring is suppressed.

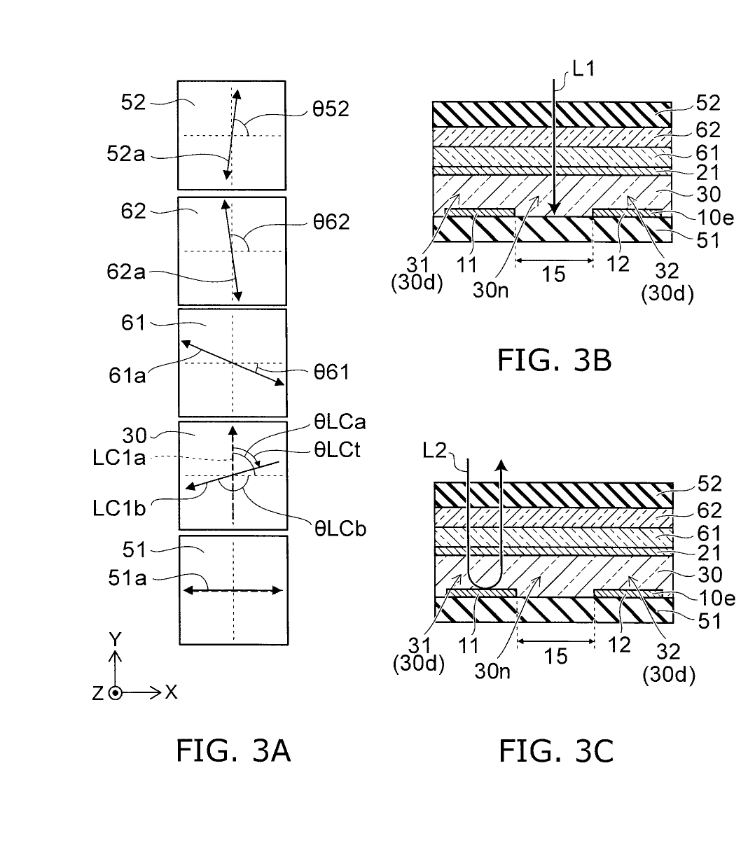

FIG. 3A to FIG. 3C are schematic views illustrating the liquid crystal display device according to the first embodiment.

FIG. 3A is a schematic plan view illustrating dispositions of the optical axes of the optical layers of the liquid crystal display device 111. FIG. 3B illustrates the light (the first light L1) incident on the non-pixel portion 30n. FIG. 3B illustrates the light (the second light L2) incident on the pixel unit 30d.

As illustrated in FIG. 3A, an absorption axis 51a of the first polarizing layer 51 is taken to be parallel to the X-axis direction. In the following description, a counterclockwise angle having the X-axis direction as a reference is described as being positive.

A first alignment angle θLCa is the angle between the X-axis direction and the alignment direction (a first alignment direction LC1a) at the first portion LCa of the liquid crystal layer 30. For example, the first alignment angle θLCa is not less than 85 degrees and not more than 95 degrees. In the example, the first alignment angle θLCa is about 90 degrees.

A second alignment angle θLCb is the angle between the X-axis direction and the alignment direction (a second alignment direction LC1b) at the second portion LCb of the liquid crystal layer 30. For example, the second alignment angle θLCb is not more than −140 degrees and not less than −180 degrees. In the example, the second alignment angle θLCb is about −160 degrees.

The absolute value of the angle (a twist angle θLCt) between the first alignment direction LC1a and the second alignment direction LC1b is not less than about 60 degrees and not more than about 80 degrees. In the example, the twist angle θLCt is 70 degrees. The twist angle θLCt corresponds to the twist angle of the long-axis direction 35D of the liquid crystal 35 inside the liquid crystal layer 30.

When the voltage is not applied to the liquid crystal layer 30, the retardation is, for example, not less than 180 nm and not more than 260 nm (the pretilt angle is small and can be ignored). In other words, the product of the thickness tLC (nm) of the liquid crystal layer 30 and the refractive index anisotropy of the liquid crystal included in the liquid crystal layer 30 is not less than 180 nanometers and not more than 260 nanometers.

A first phase difference angle θ61 between a slow axis 61a of the first phase difference layer 61 and the X-axis direction (the absorption axis 51a of the first polarizing layer 51) is, for example, not less than 20 degrees and not more than 40 degrees. In the example, the first phase difference angle θ61 is 28.5 degrees.

A second phase difference angle θ62 between a slow axis 62a of the second phase difference layer 62 and the X-axis direction (the absorption axis 51a of the first polarizing layer 51) is, for example, not less than 85 degrees and not more than 105 degrees. In the example, the second phase difference angle θ62 is 93.5 degrees.

An absorption axis 52a of the second polarizing layer 52 intersects the absorption axis 51a of the first polarizing layer 51. For example, an angle θ52 between the absorption axis 51a of the first polarizing layer 51 and the absorption axis 52a of the second polarizing layer 52 is not less than 45 degrees and not more than 100 degrees. It is more favorable for the angle θ52 to be not less than 75 degrees and not more than 95 degrees. By using such an angle θ52, a high contrast ratio and a high brightness are obtained. In the example, the angle θ52 is 79.5 degrees. In the case where the angle θ52 is less than 45 degrees, for example, the reflectance spectrum is not flat; coloration occurs easily in the bright state; and the contrast decreases easily.

As shown in FIG. 3B, the characteristics of the optical layers recited above are set so that the first light L1 that is incident on the non-pixel portion 30n (the inter-pixel region 15) substantially is absorbed by the first polarizing layer 51.

As shown in FIG. 3C, the characteristics of the optical layers recited above are set so that the second light L2 that is incident on the pixel unit 30d is reflected at the pixel electrodes 10e (the first pixel electrode 11 and the second pixel electrode 12) and passes through the second polarizing layer 52.

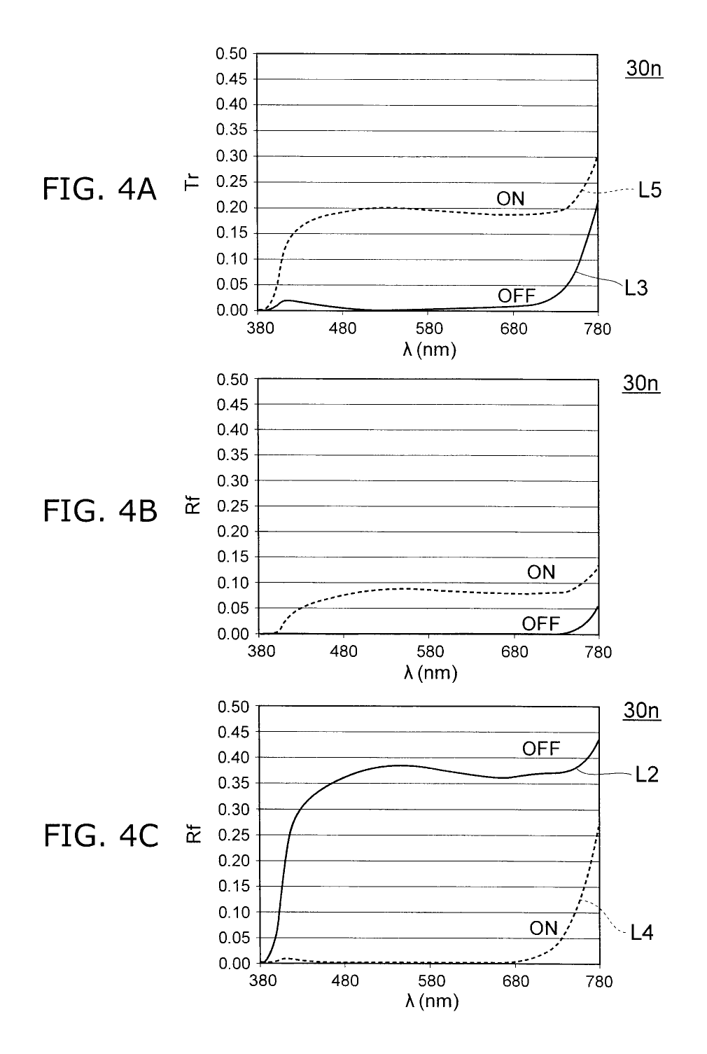

FIG. 4A to FIG. 4C are graphs illustrating characteristics of the liquid crystal display device according to the first embodiment.

FIG. 4A and FIG. 4B illustrate simulation results of the characteristics of the light passing through the non-pixel portion 30n. FIG. 4C illustrates simulation results of the characteristics of the light passing through the pixel unit 30d. In these figures, the horizontal axis is a wavelength λ (nm).

In FIG. 4A, the vertical axis is a transmittance Tr. The transmittance Tr is the ratio of the intensity of the light passing through the second polarizing layer 52, the liquid crystal layer 30, the inter-pixel region 15, and the first polarizing layer 51 to be emitted from the first polarizing layer 51 to the intensity of the light incident from the second polarizing layer 52 side. The transmittance Tr corresponds to the transmittance of the light passing through the first polarizing layer 51, the inter-pixel region 15, the liquid crystal layer 30, and the second polarizing layer 52.

In FIG. 4B, the vertical axis is a reflectance Rf. In the example, the case is assumed where a reflector is disposed on the backside of the liquid crystal display device. In the example, it is assumed that a layer of the same material as the pixel electrodes 10e is disposed as the reflector. In such a case, the reflectance Rf is the ratio of the intensity of the light that passes through the second polarizing layer 52, the liquid crystal layer 30, the inter-pixel region 15, and the first polarizing layer 51, is reflected at the reflector on the backside, passes through the first polarizing layer 51, the inter-pixel region 15, and the liquid crystal layer 30, and is emitted from the second polarizing layer 52 to the intensity of the light incident from the second polarizing layer 52 side.

In FIG. 4C, the vertical axis is the reflectance Rf. The reflectance Rf is the ratio of the intensity of the light that is reflected at the pixel electrodes 10e and emitted from the second polarizing layer 52 to the intensity of the light incident from the second polarizing layer 52 side.

In these figures, the solid lines correspond to the off-state; and the broken lines correspond to the on-state. In the off-state, the potential difference between the opposing electrode 21 and the pixel electrodes 10e is set to be, for example, 0. At this time, a voltage is not applied to the liquid crystal layer 30. In the on-state, for example, a voltage (an on-voltage) that is higher than a threshold voltage is applied between the opposing electrode 21 and the pixel electrodes 10e. At this time, the on-voltage substantially is applied to the liquid crystal layer 30. For simplification, the voltage drop due to the alignment films is ignored.

In the example, the first alignment direction LC1a is 90 degrees. The second alignment angle θLCb is about −160 degrees. The twist angle θLCt is 70 degrees. The product of the thickness tLC of the liquid crystal layer 30 and the refractive index anisotropy of the liquid crystal included in the liquid crystal layer 30 is 220 nm. The first phase difference angle θ61 of the first phase difference layer 61 is 28.5 degrees. The second phase difference angle θ62 of the second phase difference layer 62 is 93.5 degrees. The angle θ52 is 79.5 degrees.

In the off-state (the solid line (the second light L2)) as shown in FIG. 4C, the reflectance Rf at the pixel unit 30d is high, e.g., about 0.35 to 0.40. In the on-state (the broken line (a fourth light L4)), the reflectance Rf at the pixel unit 30d is low. The wavelength in this case is 550 nm. Thus, at the pixel unit 30d, the reflectance Rf changes greatly due to the applied voltage. Thereby, the display is performed. In the example, the off-state of the pixel unit 30d corresponds to the bright state of the display. The on-state of the pixel unit 30d corresponds to the dark state of the display. In the example, a normally bright (a normally white) display is performed.

On the other hand, in the off-state (the solid line (the third light L3)) as shown in FIG. 4A, the transmittance Tr at the non-pixel portion 30n is low. In the example, the transmittance Tr at the non-pixel portion 30n is higher in the on-state (the broken line (a fifth light L5)) than in the off-state (the solid line). The transmittance Tr at the non-pixel portion 30n in the on-state (the broken line) is not less than about 0.18 and not more than about 0.20. For example, an oblique electric field is applied to the non-pixel portion 30n by the on-voltage; and as a result, the liquid crystal alignment of the non-pixel portion 30n changes. Thereby, the transmittance Tr at the non-pixel portion 30n is higher than that of the off-state.

As shown in FIG. 4B, the reflectance Rf at the non-pixel portion 30n in the off-state (the solid line) is low. In the example, the reflectance Rf at the non-pixel portion 30n is higher in the on-state (the broken line) than in the off-state (the solid line). The reflectance Rf at the non-pixel portion 30n in the on-state (the broken line) is not less than about 0.07 and not more than about 0.09. In such a case as well, an oblique electric field is applied to the non-pixel portion 30n by the on-voltage; and as a result, the liquid crystal alignment of the non-pixel portion 30n changes. Thereby, the reflectance Rf at the non-pixel portion 30n is higher than that of the off-state.

At the non-pixel portion 30n, the transmittance Tr is relatively higher when the pixel unit 30d is in the on-state than when the pixel unit 30d is in the off-state. In other words, the non-pixel portion 30n is normally dark (normally black). Thus, in the example, the relationship between normally bright and normally dark is interchanged between the non-pixel portion 30n and the pixel unit 30d.

The transmittance Tr at the non-pixel portion 30n is sufficiently lower than the reflectance Rf of the bright state of the pixel unit 30d in both the off-state and the on-state. Thereby, the image on the backside that passes through the second polarizing layer 52 and reaches the viewer 80 is suppressed. Thereby, an easily-viewable display can be realized.

As illustrated in FIG. 4B, at the non-pixel portion 30n (the inter-pixel region 15), the transmittance Tr is higher in the on-state (the broken line) than in the off-state (the solid line). Therefore, there are cases where the image on the backside is viewed from the front side in the on-state. However, because the transmittance Tr is low, this is practically not problematic. In the on-state, the desired display is performed at the pixel unit 30d. By the display being performed at the pixel unit 30d, the transmission of the light at the non-pixel portion 30n is not perceived easily. On the other hand, in the off-state, the display is not performed at the pixel unit 30d; and the entire display surface has a uniform brightness. Therefore, the image on the backside is perceived easily due to the transmission of the light at the non-pixel portion 30n. In the embodiment, in the off-state, the image on the backside is not perceived easily because the light transmission of the non-pixel portion 30n is suppressed.

A small potential difference between the opposing electrode 21 and the pixel electrodes 10e corresponds to the off-state. The first voltage is the potential difference between the first pixel electrode 11 and the opposing electrode 21 in the off-state. The first voltage is, for example, a voltage that is smaller than the threshold for the alignment change of the liquid crystal layer 30.

The second light L2 is the light that passes through the second polarizing layer 52 and the first pixel unit 31, is incident on the first pixel electrode 11, is reflected at the first pixel electrode 11, and passes through the first pixel unit 31 and the second polarizing layer 52 when the potential difference between the first pixel electrode 11 and the opposing electrode 21 is the first voltage. The reflectance of the second light L2 corresponds to the characteristic illustrated by the solid line in FIG. 4B.

On the other hand, when the potential difference between the first pixel electrode 11 and the opposing electrode 21 is the first voltage, at least a portion of the first light L1 is incident on the first polarizing layer 51. Such light is emitted from the first polarizing layer 51 and is the third light L3. The transmittance of the third light L3 (the light passing through the second polarizing layer 52, the liquid crystal layer 30, the inter-pixel region 15, and the first polarizing layer 51) corresponds to the characteristic illustrated by the solid line in FIG. 4A. The transmittance Tr of the third light L3 is substantially 0; and the third light L3 is extremely dark.

At this time (in the off-state), the intensity of the second light L2 is higher than the intensity of the third light L3.

On the other hand, a large potential difference between the opposing electrode 21 and the pixel electrodes 10e corresponds to the on-state. In the on-state, the potential difference between the first pixel electrode 11 and the opposing electrode 21 is the second voltage. The second voltage is, for example, a voltage that is larger than the threshold for the alignment change of the liquid crystal layer 30. For example, the effective value of the second voltage is larger than the effective value of the first voltage.

The fourth light L4 is the light that passes through the second polarizing layer 52 and the first pixel unit 31, is incident on the first pixel electrode 11, is reflected at the first pixel electrode 11, and passes through the first pixel unit 31 and the second polarizing layer 52 in the on-state (when the potential difference between the first pixel electrode 11 and the opposing electrode 21 is the second voltage). The reflectance Rf of the fourth light L4 corresponds to the characteristic illustrated by the broken line in FIG. 4B.

In the embodiment, for example, the intensity of the second light L2 in the off-state is higher than the intensity of the fourth light L4 in the on-state.

For example, in the embodiment as illustrated in FIG. 4A to FIG. 4C, the relationship between bright and dark may be interchanged for the pixel unit 30d and the non-pixel portion 30n. For example, in the case where light (illumination light) is irradiated from the second polarizing layer 52 side onto the liquid crystal display device 110 (or 111), the following characteristics are obtained. When the potential difference between the first pixel electrode 11 and the opposing electrode 21 is the first voltage, the pixel unit 30d is in a first bright state. When the potential difference between the first pixel electrode 11 and the opposing electrode 21 is the second voltage which is different from the first voltage, the pixel unit 30d is in a first dark state. The first dark state is darker than the first bright state. When the potential difference between the first pixel electrode 11 and the opposing electrode 21 is the first voltage, the non-pixel portion 30n is in a second dark state. When the potential difference between the first pixel electrode 11 and the opposing electrode 21 is the second voltage which is different from the first voltage, the non-pixel portion 30n is in a second bright state. The second dark state is darker than the second bright state.

For example, the effective value of the second voltage is larger than the effective value of the first voltage. In such a case, a normally bright display is performed at the pixel unit 30d. On the other hand, in the embodiment, the effective value of the second voltage may be smaller than the effective value of the first voltage. In such a case, a normally dark display is performed at the pixel unit 30d.

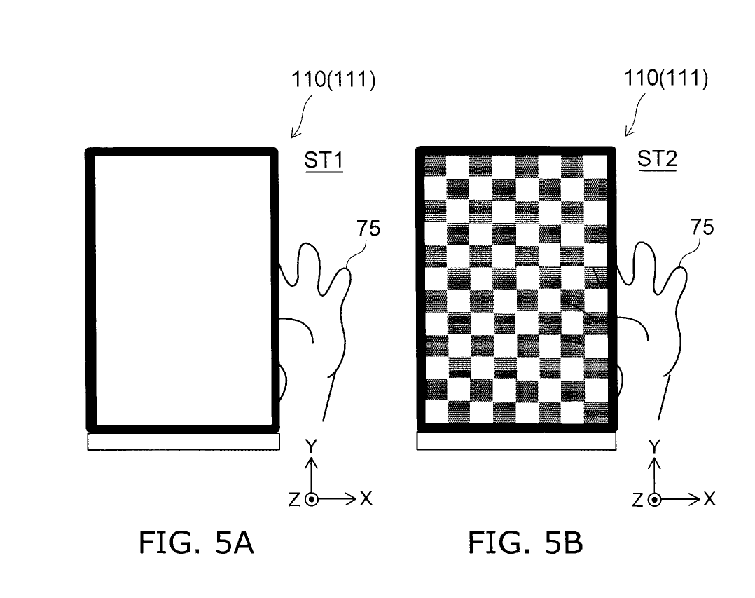

FIG. 5A and FIG. 5B are schematic views illustrating operations of the liquid crystal display device according to the first embodiment.

FIG. 5A corresponds to a non-display state ST1; and FIG. 5B corresponds to a display state ST2. In the non-display state ST1, the voltage between the pixel electrodes 10e and the opposing electrode 21 is lower than a threshold. For example, the voltage is substantially 0 volts. At this time, the voltage that is applied to the liquid crystal layer 30 is substantially 0 volts. The non-display state ST1 is, for example, the off-state. In the display state ST2, desired potentials that correspond to the display content are set for the multiple pixel electrodes 10e. Various voltages that correspond to the display content are set for the voltages between the opposing electrode 21 and each of the multiple pixel electrodes 10e. In the example, a checkered pattern is displayed in the display state ST2 as an example.

In the non-display state ST1 as illustrated in FIG. 5A, the image of an object 75 disposed on the backside of the liquid crystal display device 110 (111) is not easily viewed and substantially is not perceived. This is because the transmittance Tr (and the reflectance Rf) at the non-pixel portion 30n is low.

As illustrated in FIG. 5B, for example, there are cases where the transmittance Tr of the non-pixel portion 30n is higher in the display state ST2 than in the non-display state ST1; and the object 75 on the backside is transmitted and is viewable. However, in the display state ST2, the desired display content is displayed; and the brightness of the display region is nonuniform. Therefore, in the display state ST2, it is not easy to view the object 75 on the backside; and there are substantially no problems.

In the non-display state ST1, if the object 75 on the backside could be viewed via the non-pixel portion 30n, the image of the object 75 would be perceived easily because the brightness of the display region is uniform. On the other hand, in the display state ST2, even if the object 75 on the backside is viewed via the non-pixel portion 30n, the image of the object 75 is not perceived easily in most cases. In the embodiment, for example, in the off-state (the non-display state ST1), the design is such that the object 75 on the backside of the display device is not easily transmitted and perceived. Thereby, an easily-viewable liquid crystal display device can be provided.

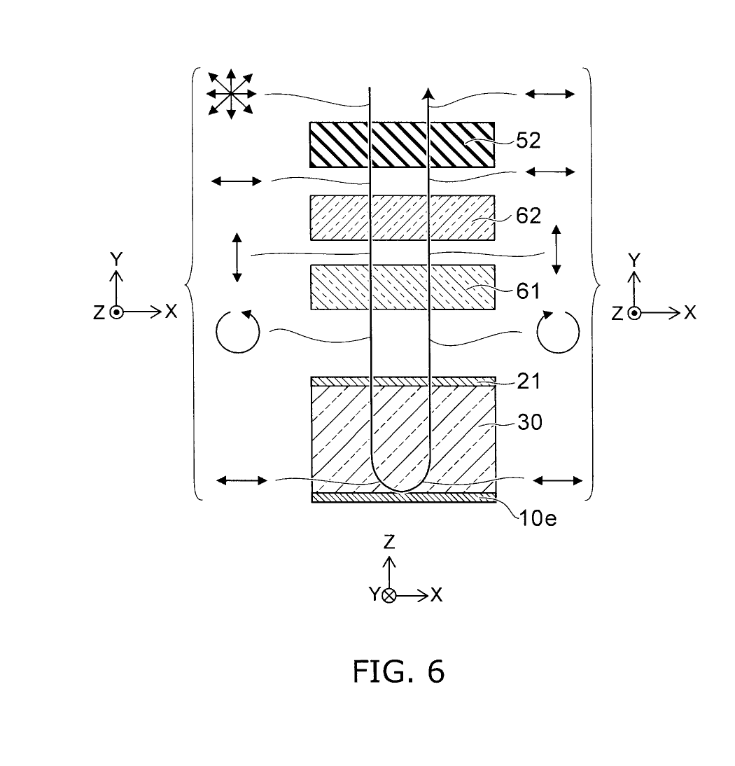

FIG. 6 is a schematic view illustrating characteristics of the liquid crystal display device according to the first embodiment.

FIG. 6 illustrates an example of polarization states of the light of the liquid crystal display device 111 and the cross section of the liquid crystal display device 111.

As illustrated in FIG. 6, the light prior to being incident on the second polarizing layer 52 is natural light and is not polarized. After passing through the second polarizing layer 52, the light is substantially linearly polarized light. After passing through the second phase difference layer 62, the polarization direction of the light is rotated 90 degrees. After passing through the first phase difference layer 61, the light is substantially circularly polarized light. In the example, the circularly polarized light is clockwise. The light that has passed through the liquid crystal layer 30 directly prior to being incident on the pixel electrode 10e is substantially linearly polarized light. The polarization state of the light reflected at the pixel electrode 10e substantially is maintained.

The light that is reflected at the pixel electrode 10e is substantially circularly polarized light after passing through the liquid crystal layer 30. The circularly polarized light is clockwise. After passing through the first phase difference layer 61, the light is linearly polarized light. After passing through the second phase difference layer 62, the polarization direction of the light is rotated 90 degrees. The light is incident on the second polarizing layer 52. The axis direction of the light (the linearly polarized light) incident on the second polarizing layer 52 is aligned with the transmission direction of the second polarizing layer 52. Thereby, the bright state is obtained.

For example, the state illustrated in FIG. 6 is the state in which the voltage is not applied to the liquid crystal layer 30 (the potential difference is, for example, the first voltage).

On the other hand, when a voltage is applied to the liquid crystal layer 30, the effective retardation of the liquid crystal layer 30 changes; and the light directly prior to being incident on the pixel electrode 10e is, for example, no longer linearly polarized light. The light is reflected at the pixel electrode 10e, passes through the liquid crystal layer 30, the first phase difference layer 61, and the second phase difference layer 62, and is incident on the second polarizing layer 52. The light that is incident on the second polarizing layer 52 has a polarized light component along the absorption axis of the second polarizing layer 52 and is absorbed by the second polarizing layer 52. In other words, the dark state is obtained.

On the other hand, in the inter-pixel region 15, the light that is incident on the second polarizing layer 52 and passes through the second phase difference layer 62, the first phase difference layer 61, and the liquid crystal layer 30 is incident on the first polarizing layer 51. At this time, the absorption axis of the first polarizing layer 51 is disposed along the polarization direction of the light passing through the liquid crystal layer 30. Thereby, in the inter-pixel region 15, the light that passes through the liquid crystal layer 30 is absorbed by the first polarizing layer 51.

It is favorable for a phase difference layer not to be provided between the liquid crystal layer 30 and the first polarizing layer 51. In the case where a phase difference layer is provided between the liquid crystal layer 30 and the first polarizing layer 51, for example, the light that passes through the inter-pixel region 15 changes from linearly polarized light to elliptically polarized light in the phase difference layer. A portion of the components of the elliptically polarized light passes through the first polarizing layer 51. Namely, the light from the backside undesirably passes through the second polarizing layer 52.

In the embodiment, it is favorable for the retardation in the region between the liquid crystal layer 30 and the first polarizing layer 51 to be, for example, 50 nm or less (and more favorably, 20 nm or less). Thereby, the elliptically polarized light recited above can be suppressed. The transmittance Tr can be lower in the inter-pixel region 15. A brighter display having a higher contrast ratio is possible.

Further, for example, in the case where the phase difference layer is provided between the liquid crystal layer 30 and the first polarizing layer 51, the liquid crystal display device becomes thicker due to the thickness of the phase difference layer; and the liquid crystal display device becomes heavy. Therefore, it is favorable for a phase difference layer not to be provided between the liquid crystal layer 30 and the first polarizing layer 51.

In the liquid crystal display devices 110 and 111 according to the embodiment, polarizing layers are disposed at both front and back. As described above, the polarizing layers are fixed respectively to the first substrate unit 10u and the second substrate unit 20u by, for example, adhesive layers (in the case where phase difference layers are provided, the polarizing layers are fixed via the phase difference layers). The mechanical strength of the liquid crystal display device is increased by disposing polarizing layers (e.g., polarizing plates) having similar characteristics at both front and back. For example, warp of the liquid crystal display device is suppressed.

For example, a third reference example may be considered in which the second polarizing layer 52 is provided, and a light absorption layer is provided instead of the first polarizing layer 51. In such a case, the configurations of the front and back are asymmetric. Therefore, a large warp occurs easily in the liquid crystal display device. For example, polarizing layers (polarizing plates) are manufactured by stretching. Therefore, the polarizing layer may contract due to the thermal history applied to the polarizing layer, etc. By disposing polarizing layers having similar characteristics at the front and back, the warp that occurs can be small because the contraction occurs at both front and back. A highly reliable liquid crystal display device can be provided.

### Second Embodiment

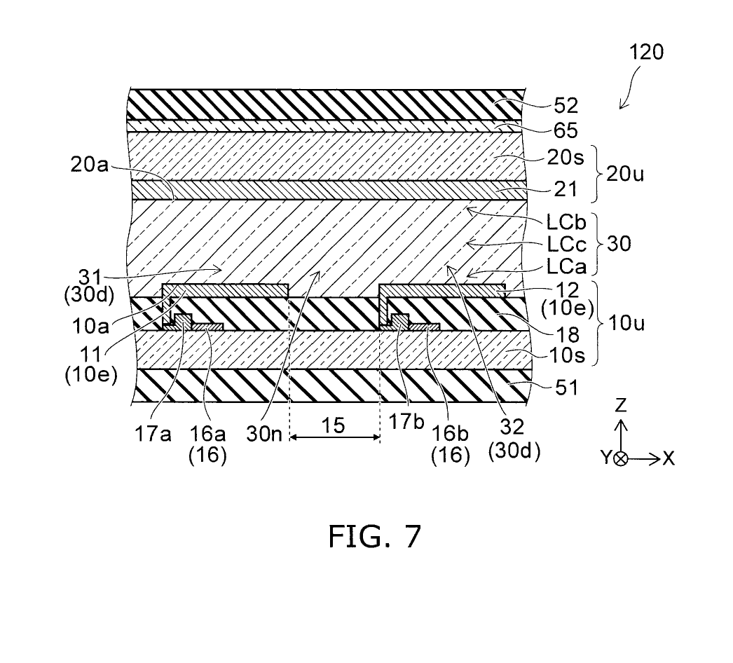

FIG. 7 is a schematic cross-sectional view illustrating a liquid crystal display device according to a second embodiment.

As shown in FIG. 7, an optical layer 65 is further provided in the liquid crystal display device 120 according to the embodiment. The optical layer 65 is provided between the second polarizing layer 52 and the opposing electrode 21. Otherwise, the liquid crystal display device 120 is similar to the liquid crystal display device 110; and a description is omitted.

The optical layer 65 may be considered to be a portion of the second substrate unit 20u. The optical layer 65 and the second substrate unit 20u may be separate entities.

The optical layer 65 modifies the travel direction of the light incident on the optical layer 65. For example, the optical layer 65 diffuses (e.g., scatters) the light incident on the optical layer 65. For example, the optical layer 65 changes the intensity of the diffuse light (e.g., the scattered light) of the light incident on the optical layer 65 according to the direction (the direction in the X-Y plane) of the light incident on the optical layer 65. Examples of the configuration and characteristics of the optical layer 65 are described below.

The polarization characteristics of the light that is incident are substantially maintained in the optical layer 65. By using the optical layer 65, the reflection of images at the pixel electrodes 10e is suppressed even in the case where the pixel electrodes 10e have a relatively high specular reflectivity; and an easily-viewable display is possible.

The haze of the optical layer 65 is, for example, not less than 70% and not more than 95%. Thereby, good scattering properties are obtained; and a display having a good contrast ratio can be provided.

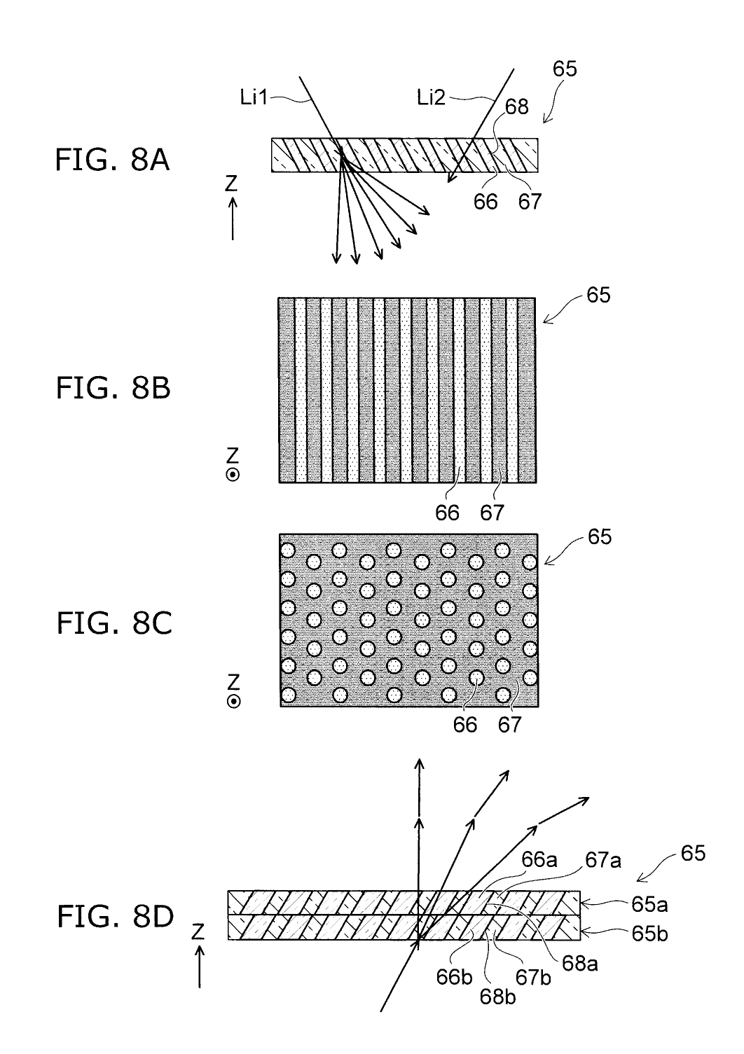

FIG. 8A to FIG. 8D are schematic views illustrating a portion of the liquid crystal display device according to the second embodiment.

These drawings illustrate the optical layer 65. FIG. 8A is a schematic cross-sectional view illustrating the optical layer 65. FIG. 8B is a schematic plan view illustrating the optical layer 65. FIG. 8C is a schematic plan view showing the optical layer 65 of another example. FIG. 8D is a schematic cross-sectional view showing another example of the optical layer 65.

As illustrated in FIG. 8A, the optical layer 65 includes multiple first optical units 66 and a second optical unit 67. The multiple first optical units 66 are disposed in the X-Y plane (in a plane parallel to the first major surface 10a). The multiple first optical units 66 are light-transmissive. The second optical unit 67 is provided between any two of the multiple first optical units 66. The second optical unit 67 also is light-transmissive. In the example, multiple second optical units 67 are provided. The multiple first optical units 66 and the multiple second optical units 67 are disposed alternately. For example, a boundary 68 between the second optical unit 67 and at least one selected from the multiple first optical units 66 is tilted with respect to the X-Y plane. The refractive index of the second optical units 67 is higher or lower than the refractive index of the first optical units 66.

For example, the intensity of scattered light of the optical layer 65 for the light (a first incident light Li1) incident on the optical layer 65 from a first incident direction is different from the intensity of scattered light of the optical layer 65 for the light (a second incident light Li2) incident on the optical layer 65 from a second incident direction. Here, the direction of the first incident direction in the X-Y plane is different from the direction of the second incident direction in the X-Y plane.

For example, the intensity of scattered light of the optical layer 65 for the first incident light Li1 is higher than the intensity of scattered light of the optical layer 65 for the second incident light Li2. For example, the first incident light Li1 is scattered and diffused by the optical layer 65. On the other hand, for the second incident light Li2, the level of the scattering (the diffusion) of the optical layer 65 is low; and the transmissivity is high. Such scattering characteristics are obtained by, for example, the boundary 68 being tilted with respect to the X-Y plane. The optical layer 65 is, for example, an anisotropic scattering layer. The optical layer 65 is an anisotropic forward scattering film.

For example, a region having a high refractive index and a region having a low refractive index are provided in the optical layer 65. The optical layer 65 is, for example, a transparent film. For example, the level of the scattering of the optical layer 65 is different between the incident directions of the light. The optical layer 65 has a scattering central axis. The scattering central axis corresponds to, for example, the optical axis of the first incident light Li1 illustrated in FIG. 8A. The scattering central axis corresponds to, for example, the incident direction of the light that scatters most.

As illustrated in FIG. 8B, the multiple first optical units 66 have band configurations. For example, the first optical units 66 and the second optical units 67 extend along one direction intersecting (e.g., orthogonal to) the Z-axis direction. In the example, the optical layer 65 is, for example, a louver structure-type.

In the other example illustrated in FIG. 8C, the multiple first optical units 66 have island configurations that are separated from each other. In the example, the optical layer 65 is, for example, a columnar structure-type.

In the example illustrated in FIG. 8D, the optical layer 65 includes multiple layers (a first layer 65a, a second layer 65b, etc.). These layers are stacked along the Z-axis direction. The first layer 65a includes multiple first optical units 66a that are light-transmissive and disposed in the X-Y plane, and a second optical unit 67a that is light-transmissive and provided between two of the multiple first optical units 66a. The refractive index of the second optical unit 67a is different from the refractive index of the multiple first optical units 66a. In such a case as well, a boundary 68a between the second optical unit 67a and at least one selected from the multiple first optical units 66a is tilted with respect to the X-Y plane.

The second layer 65b includes multiple third optical units 66b that are light-transmissive and disposed in the X-Y plane, and a fourth optical unit 67b that is light-transmissive and provided between two of the multiple third optical units 66b. The refractive index of the fourth optical unit 67b is different from the refractive index of the multiple third optical units 66b. A boundary 68b between the fourth optical unit 67b and at least one selected from the multiple third optical units 66b is tilted with respect to the X-Y plane. For example, the extension direction of the boundary 68b is aligned with the extension direction of the boundary 68a. For example, the angle between the plane including the boundary 68b and the plane including the boundary 68a may be 30 degrees or less. For example, the scattering area is enlarged by providing multiple layers in the optical layer 65. By providing multiple layers in the optical layer 65, the coloration (e.g., the occurrence of rainbow colors), etc., can be suppressed. The number of layers provided in the optical layer 65 may be three or more.

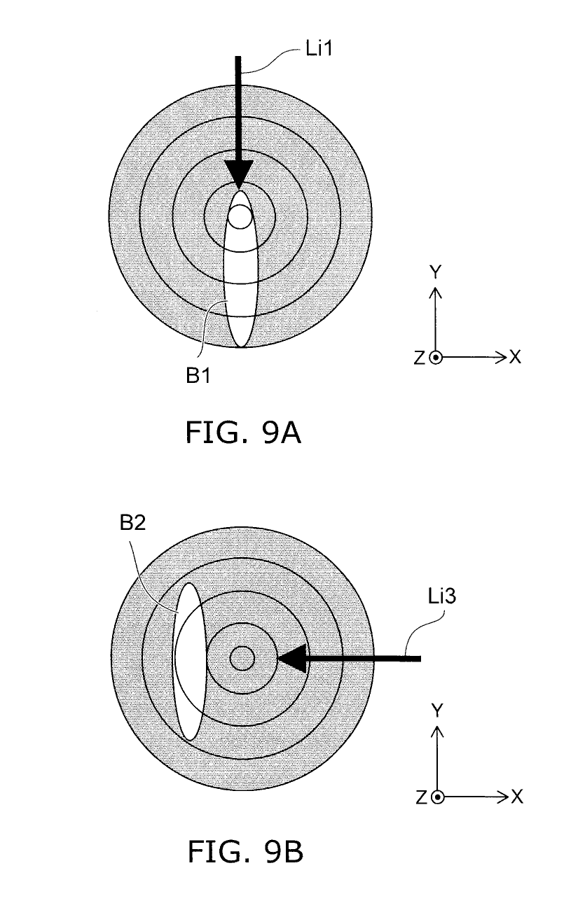

FIG. 9A and FIG. 9B are schematic plan views illustrating characteristics of the liquid crystal display device according to the second embodiment.

These drawings are schematic views illustrating characteristics of the optical layer 65 and schematically illustrate the intensity of light passing through the optical layer 65 when the light is incident on the optical layer 65. FIG. 9A corresponds to when the first incident light Li1 is incident. In the example, the first incident light Li1 is incident on the optical layer 65 along the Y-Z plane. The incident angle of the first incident light Li1 (the angle between the Z-axis direction and the first incident light Li1) is 30 degrees. FIG. 9A corresponds to the case where, for example, the light is incident from a direction parallel to the scattering central axis. FIG. 9B corresponds to when a third incident light Li3 is incident. In the example, the third incident light Li3 is incident on the optical layer 65 along the X-Z plane. The incident angle of the third incident light Li3 (the angle between the Z-axis direction and the third incident light Li3) is 30 degrees. FIG. 9B corresponds to, for example, the case where the light is incident from a direction perpendicular to the scattering central axis.

The concentric circles illustrated in these drawings correspond to angles (equiangular lines) having the Z-axis direction as the reference. The center of the concentric circles corresponds to the transmitted light (the perpendicularly emitted light) being emitted from the optical layer 65 substantially along the Z-axis direction. Bright regions B1 and B2 that are illustrated in these drawings are regions where the intensity of the transmitted light is high.

As shown in FIG. 9A, for example, the intensity of the perpendicularly emitted light is high for the first incident light Li1 along the Y-axis direction. The intensity of the transmitted light emitted in the direction tilted in the Y-Z plane also is high.

As shown in FIG. 9B, for example, the intensity of the perpendicularly emitted light is low for the third incident light Li3 along the X-axis direction. The intensity of the transmitted light in the direction tilted in the X-Z plane (the direction tilted from the perpendicular direction) is high.

Thus, in the optical layer 65, the intensity of the light of the optical layer 65 for the light (e.g., the first incident light Li1) incident on the optical layer 65 from the first incident direction is different from the intensity of the light of the optical layer 65 for the light (the second incident light Li2, the third incident light Li3, etc.) incident on the optical layer 65 from the second incident direction.

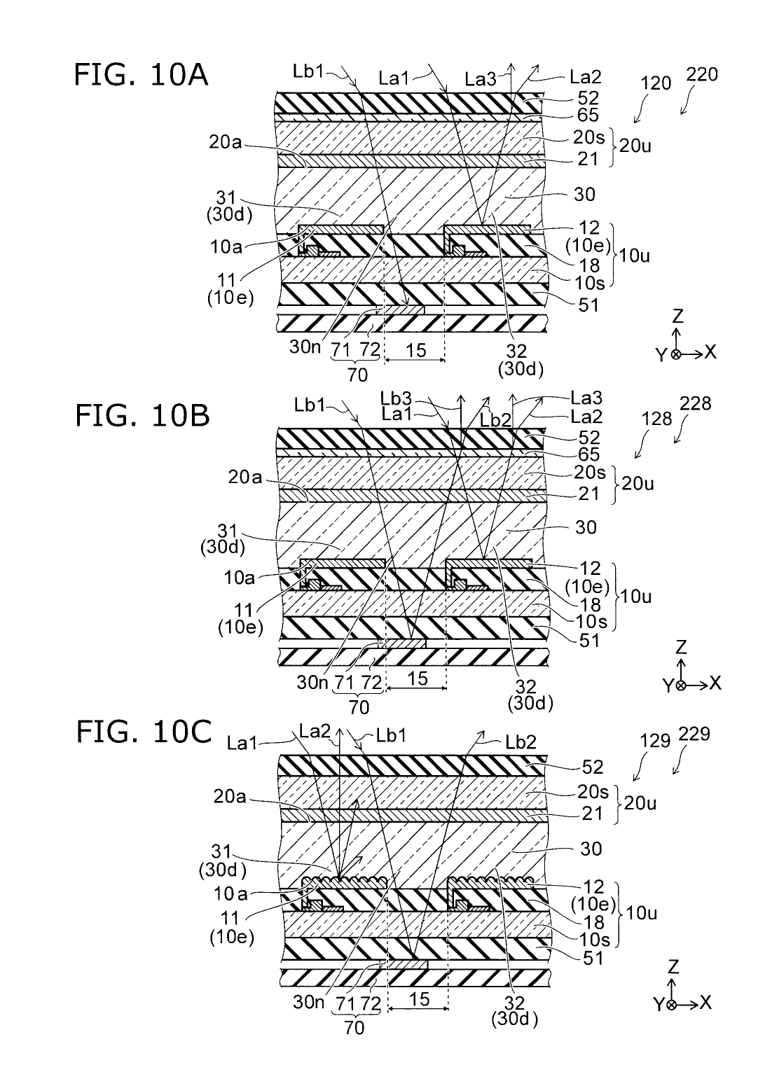

FIG. 10A to FIG. 10C are schematic cross-sections illustrating characteristics of liquid crystal display devices and electronic devices.

FIG. 10A illustrates characteristics of a liquid crystal display device 120 according to the embodiment. The drawing illustrates the configuration and characteristics of an electronic device 220 that uses the liquid crystal display device 120. FIG. 10B and FIG. 10C respectively illustrate characteristics of a liquid crystal display device 128 of a fourth reference example and a liquid crystal display device 129 of a fifth reference example. FIG. 10B and FIG. 10C illustrate the configuration and characteristics of electronic devices 228 and 229 that use liquid crystal display devices 128 and 129.

As illustrated in FIG. 10A, the electronic device 220 includes the liquid crystal display device 120 and an electronic member 70. Any liquid crystal display device according to the embodiments may be used as the liquid crystal display device. The first polarizing layer 51, the first substrate unit 10u, the liquid crystal layer 30, and the second substrate unit 20u are disposed between the electronic member 70 and the second polarizing layer 52. Thus, the liquid crystal display device 120 is applicable to the electronic device 220, etc. The electronic device 220 includes any device (e.g., an electronic device) that includes a display unit such as, for example, an information terminal device, a computer, a camera, etc.

In the example, the electronic member 70 includes a substrate 72 and a reflective unit 71. The reflective unit 71 is disposed between the substrate 72 and the liquid crystal display device 120. The substrate 72 is a substrate on which, for example, an electronic component is mounted. The reflective unit 71 is an interconnect or the like provided on the substrate 72. The reflective unit 71 may be an electronic element (a resistor, a diode, a transistor, etc.) mounted on the substrate 72. The reflective unit 71 reflects light. For example, at least a portion of the reflective unit 71 overlaps the inter-pixel region 15 (e.g., the non-pixel portion 30n) when projected onto the X-Y plane. For example, the reflectance of the reflective unit 71 is different from the reflectance of the substrate 72.

For example, light Lb1 is incident on the liquid crystal display device 120 from the second polarizing layer 52 side. In the liquid crystal display device 120, the light Lb1 substantially is not incident on the electronic member 70 because the transmittance Tr of the non-pixel portion 30n is low. Therefore, the electronic member 70 substantially is not viewed. On the other hand, light La1 is reflected at the pixel electrode 10e and emitted as light La1. The travel direction of a portion of the light La1 that is reflected at the pixel electrode 10e is modified at the optical layer 65. For example, the travel direction of light La3 is modified to be aligned with the frontward direction (the Z-axis direction); and the light La3 is viewed by the viewer 80. The desired display can be provided to the viewer.

On the other hand, in the liquid crystal display device 128 of the fourth reference example illustrated in FIG. 10B, the transmittance Tr of the non-pixel portion 30n is high. For example, the transmittance Tr of the non-pixel portion 30n is high when the angles of the polarizing layers, etc., are inappropriate. In other words, at least a portion of the first light L1 that passes through the second polarizing layer 52, the liquid crystal layer 30, and the inter-pixel region 15 is incident on the first polarizing layer 51; but the at least a portion of the first light L1 is not sufficiently absorbed by the first polarizing layer 51. In such a case, the light Lb1 that is incident on the liquid crystal display device 128 passes through the first polarizing layer 51, is incident on the electronic member 70, is reflected at the electronic member 70, and is emitted from the liquid crystal display device 128. In other words, light Lb2 is produced. The travel direction of a portion of the light reflected at the electronic member 70 is modified at the optical layer 65 and emitted from the liquid crystal display device 128 as light Lb3. The light Lb3 is, for example, light that is emitted in the frontward direction (the Z-axis direction) and is viewed by the viewer 80. In other words, in the fourth reference example, the electronic member 70 is viewed by the viewer 80 from the inter-pixel region 15. In particular, the pattern configuration of the reflective unit 71 is perceived easily in the case where the electronic member 70 includes the reflective unit 71 and the substrate 72, and the end of the reflective unit overlaps the inter-pixel region 15. Therefore, it is particularly effective for the transmittance Tr (the reflectance Rf) of the inter-pixel region 15 (the non-pixel portion 30n) to be low in the liquid crystal display device that uses the optical layer 65.

In the embodiment, the perception of the electronic member 70 by the viewer 80 can be suppressed even in the case where the optical layer 65 is used because the transmittance Tr (the reflectance Rf) of the inter-pixel region 15 (the non-pixel portion 30n) is low. Thereby, an easily-viewable display can be provided.

On the other hand, in the liquid crystal display device 129 of the fifth reference example as illustrated in FIG. 10C, the optical layer 65 is not provided; and the pixel electrode 10e has diffuse reflectivity. For example, an unevenness is provided in the front surface of the pixel electrode 10e. Specular reflections are suppressed because the pixel electrode 10e has diffuse reflectivity. In the fifth reference example, relatively speaking, problems of the electronic member 70 being viewed by the viewer 80 via the inter-pixel region 15 do not occur easily even in the case where the transmittance Tr of the non-pixel portion 30n is high. For example, the light Lb1 passes through the inter-pixel region 15 and the first polarizing layer 51, is incident on the electronic member 70, is reflected at the electronic member 70, and is emitted as the light Lb2. At this time, the light is not emitted in the frontward direction because the optical layer 65 is not provided. Therefore, the electronic member 70 is not easily perceived by the viewer 80 viewing from the frontward direction. The pattern configuration of the reflective unit 71 is not easily perceived.

Thus, in the case where the optical layer 65 is used, the perception of the electronic member 70 can be suppressed effectively by reducing the transmittance Tr (the reflectance Rf) of the inter-pixel region 15 (the non-pixel portion 30n). In particular, in the case where the optical layer 65 is combined with the pixel electrode 10e that has specular reflectivity, the perception of the electronic member 70 can be suppressed effectively by reducing the transmittance Tr (the reflectance Rf) of the inter-pixel region 15 (the non-pixel portion 30n).

For example, in the electronic device 220, the intensity of the light produced when at least a portion of the first light Li is incident on the first polarizing layer 51, is reflected at the electronic member 70, passes through the first polarizing layer 51, the first substrate unit 10u, the liquid crystal layer 30, and the second substrate unit 20u, and is emitted from the second polarizing layer 52 is lower than the intensity of the second light L2. The second light L2 is the light that passes through the second polarizing layer 52 and the first pixel unit 31 (the portion of the liquid crystal layer 30 between the first pixel electrode 11 and the opposing electrode), is incident on the first pixel electrode 11, is reflected at the first pixel electrode 11, and passes through the first pixel unit 31 and the second polarizing layer 52 when the potential difference between the first pixel electrode 11 and the opposing electrode 21 is the first voltage (e.g., the off-voltage).

For example, in the electronic device 220, the intensity of the light produced when at least a portion of the first light L1 is incident on the first polarizing layer 51, is reflected at the electronic member 70, passes through the first polarizing layer 51, the first substrate unit 10u, the liquid crystal layer 30, and the second substrate unit 20u, and is emitted from the second polarizing layer 52 is lower than the intensity of the fourth light L4. The fourth light L4 is the light that passes through the second polarizing layer 52 and the first pixel unit 31, is incident on the first pixel electrode 11, is reflected at the first pixel electrode 11, and passes through the first pixel unit 31 and the second polarizing layer 52 when the potential difference between the first pixel electrode 11 and the opposing electrode 21 is the second voltage (e.g., the on-voltage).

According to the electronic device 220 according to the embodiment, an easily-viewable display can be provided.

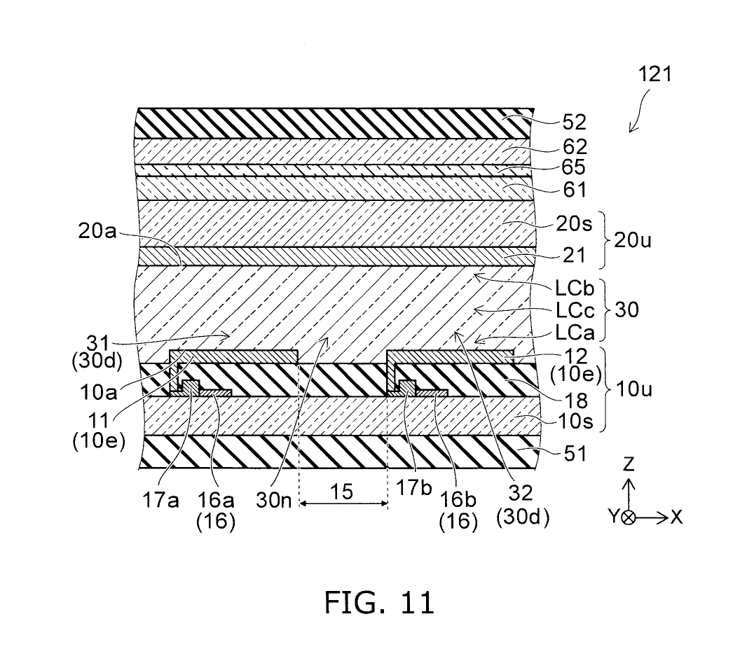

FIG. 11 is a schematic cross-sectional view illustrating another liquid crystal display device according to the second embodiment.

As shown in FIG. 11, the optical layer 65 is disposed between the first phase difference layer 61 and the second phase difference layer 62 in the liquid crystal display device 121 according to the embodiment. Otherwise, the liquid crystal display device 121 is similar to the liquid crystal display device 111.

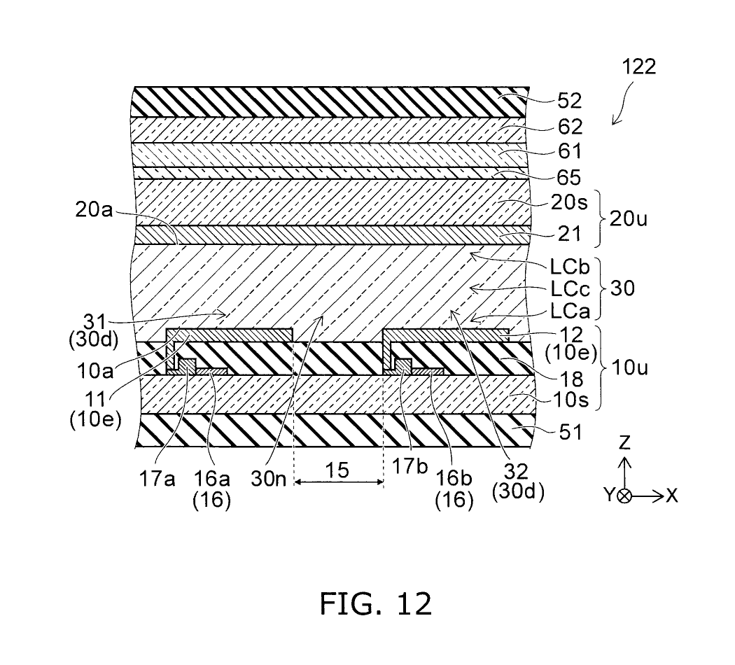

FIG. 12 is a schematic cross-sectional view illustrating another liquid crystal display device according to the second embodiment.

As shown in FIG. 12, the optical layer 65 is disposed between the first phase difference layer 61 and the opposing electrode 21 in the liquid crystal display device 122 according to the embodiment. In the example, the optical layer 65 is disposed between the first phase difference layer 61 and the second substrate 20s. Otherwise, the liquid crystal display device 122 is similar to the liquid crystal display device 111.

In the liquid crystal display devices 121 and 122 as well, an easily-viewable display is possible.

### Third Embodiment

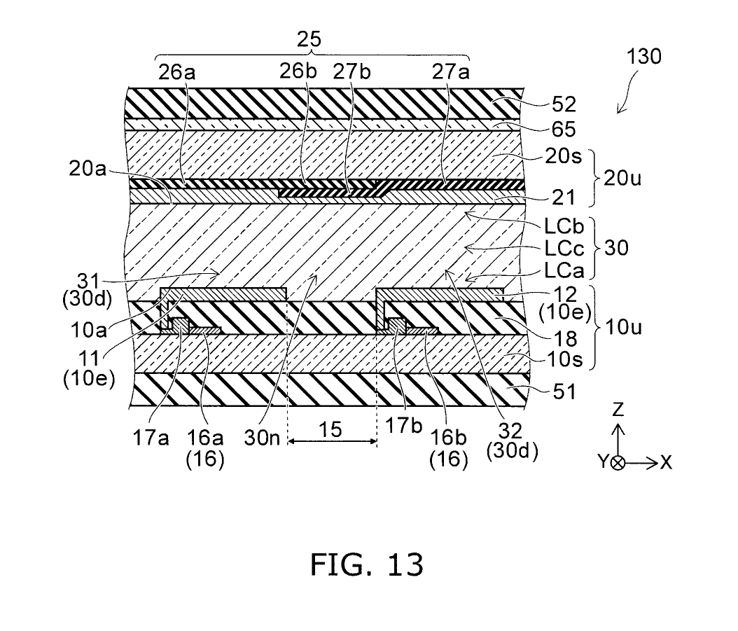

FIG. 13 is a schematic cross-sectional view illustrating a liquid crystal display device according to a third embodiment.

In the liquid crystal display device 130 according to the embodiment as shown in FIG. 13, a colored layer 25 is further provided in the second substrate unit 20u. The opposing electrode 21 is disposed between the colored layer 25 and the liquid crystal layer 30. A planarization layer (an overcoat layer) may be provided between the colored layer 25 and the opposing electrode 21. Otherwise, the liquid crystal display device 130 is similar to the liquid crystal display device 120; and a description is omitted.

The colored layer 25 includes a first colored portion 26b and a second colored portion 27b. The first colored portion 26b overlaps the inter-pixel region 15 when projected onto the first major surface 10a (or the X-Y plane). The first colored portion 26b has a first color. The second colored portion 27b overlaps the inter-pixel region 15 and the first colored portion 26b when projected onto the first major surface 10a (or the X-Y plane). The second colored portion 27b has a second color that is different from the first color.

For example, one selected from the first color and the second color is red; and the other selected from the first color and the second color is blue. One selected from the first color and the second color may be red; and the other selected from the first color and the second color may be green. One selected from the first color and the second color may be blue; and the other selected from the first color and the second color may be green.

For example, one selected from the first color and the second color is magenta; and the other selected from the first color and the second color is cyan. One selected from the first color and the second color may be magenta; and the other selected from the first color and the second color may be yellow. One selected from the first color and the second color may be cyan; and the other selected from the first color and the second color may be yellow.

The light that passes through the inter-pixel region 15 is absorbed because the first colored portion 26b and the second colored portion 27b are provided to overlap the inter-pixel region 15. Thereby, the transmittance in the inter-pixel region 15 is reduced further. Thereby, the perception of the image on the backside is suppressed further. The transmittance can be reduced in a wide wavelength region by setting one selected from the first color and the second color to be red and setting the other selected from the first color and the second color to be blue.

A layer that is used as a color filter for the display may be used as the colored layer 25.

In the example, the colored layer 25 further includes a first color filter 26a and a second color filter 27a. The first color filter 26a is provided between the first pixel electrode 11 and the second polarizing layer 52. The first color filter 26a has, for example, the first color recited above.

The second color filter 27a is provided between the second pixel electrode 12 and the second polarizing layer 52. The second color filter 27a has a third color that is different from the first color. The third color may be the same as or different from the second color.

The first colored portion 26b may be continuous with or separated from the first color filter 26a. The second colored portion 27b may be continuous with or separated from the second color filter 27a.

For example, the colored layer 25 may further include a third colored portion (not shown). The third colored portion overlaps the inter-pixel region 15, the first colored portion 26b, and the second colored portion 27b when projected onto the first major surface 10a (or the X-Y plane). The third colored portion has a color (e.g., the third color) that is different from the first color and different from the second color. By providing the third colored portion, the transmittance of the light passing through the inter-pixel region 15 can be reduced further.

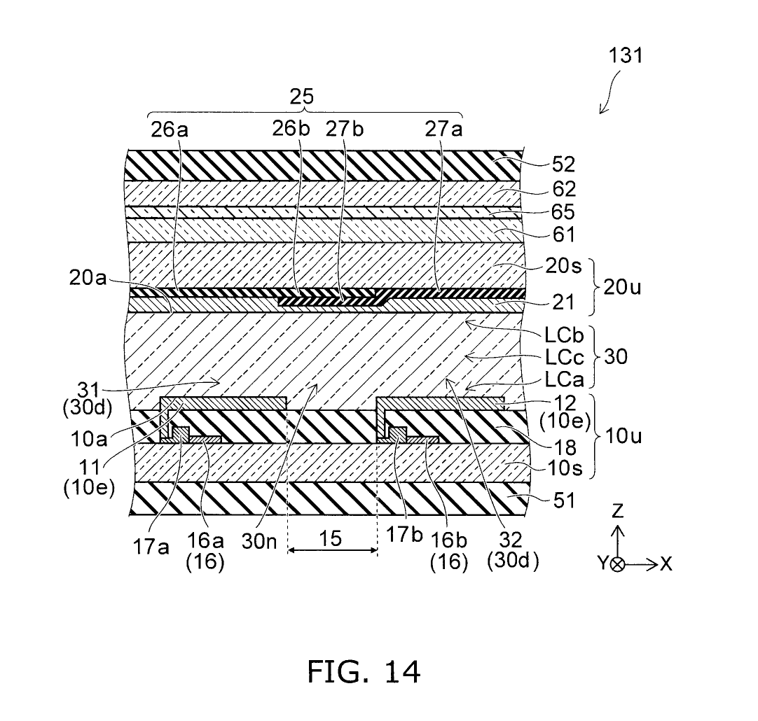

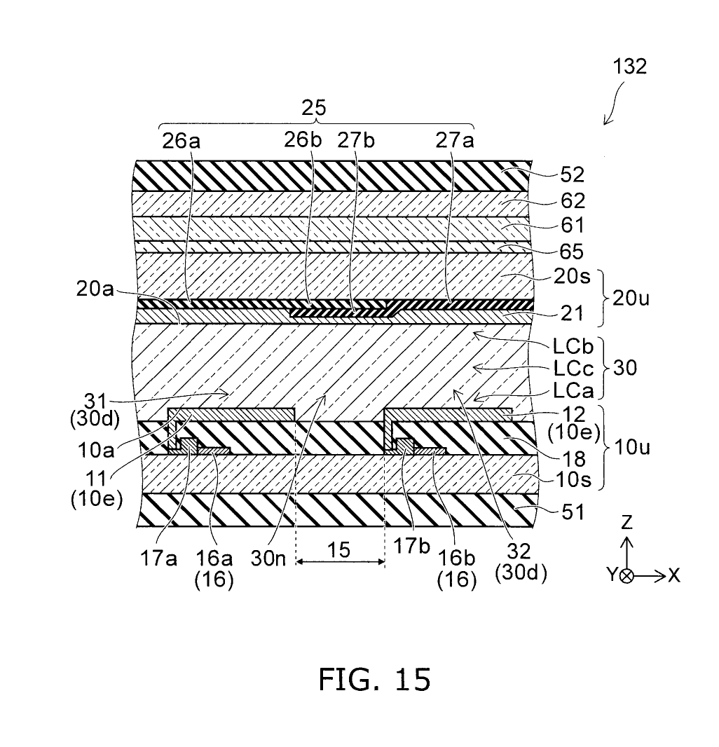

FIG. 14 and FIG. 15 are schematic cross-sectional views illustrating other liquid crystal display devices according to the third embodiment.

As shown in FIG. 14 and FIG. 15, the colored layer 25 is provided in the liquid crystal display devices 131 and 132 according to the embodiment. Otherwise, the liquid crystal display devices 131 and 132 are similar to the liquid crystal display devices 121 and 122. In the liquid crystal display devices 131 and 132 as well, the transmittance of the light passing through the inter-pixel region 15 can be reduced.

The electronic device according to the embodiment includes the liquid crystal display devices according to the embodiments recited above and modifications of the liquid crystal display devices. For example, the electronic device includes the electronic member recited above and one selected from the liquid crystal display devices according to the embodiments. In the electronic device according to the embodiment, an easily-viewable display can be provided.

According to the embodiments, an easily-viewable liquid crystal display device and an electronic device can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, embodiments of the invention are described with reference to specific examples. However, the invention is not limited to these specific examples. For example, one skilled in the art may similarly practice the invention by appropriately selecting specific configurations of components included in the liquid crystal display device such as the polarizing layer, the pixel electrode, the opposing electrode, the interconnect, the switching element, the insulating layer, the substrate unit, the liquid crystal layer, the phase difference layer, and the optical layer, specific configurations of components included in the electronic device such as the electronic member, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all liquid crystal display devices practicable by an appropriate design modification by one skilled in the art based on the liquid crystal display devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A liquid crystal display device, comprising:
a first polarizing layer;
a second polarizing layer;
a first substrate unit provided between the first polarizing layer and the second polarizing layer, the first substrate unit including a first pixel electrode, a second pixel electrode, and an inter-pixel region provided between the first pixel electrode and the second pixel electrode, the first pixel electrode and the second pixel electrode being light-reflective and disposed in a first major surface intersecting a direction from the first polarizing layer toward the second polarizing layer;
a second substrate unit provided between the first substrate unit and the second polarizing layer, an opposing electrode being provided in a second major surface of the second substrate unit, the opposing electrode being light-transmissive; and
a liquid crystal layer provided between the first major surface and the second major surface,
at least a portion of a first light passing through the second polarizing layer, the liquid crystal layer, and the inter-pixel region being able to be incident on the first polarizing layer.

2. The device according to claim 1, wherein the first polarizing layer absorbs at least a portion of the at least a portion of the first light.

3. The device according to claim 1, wherein
an intensity of a second light is higher than an intensity of a light passing through the second polarizing layer, the liquid crystal layer, the inter-pixel region, and the first polarizing layer, the second light passing through the second polarizing layer, passing through a first pixel unit of the liquid crystal layer, being incident on the first pixel electrode, being reflected at the first pixel electrode, passing through the first pixel unit, and passing through the second polarizing layer when a potential difference between the first pixel electrode and the opposing electrode is a first voltage, the first pixel unit being provided between the first pixel electrode and the opposing electrode.

4. The device according to claim 1, wherein
an intensity of a second light is higher than an intensity of a fourth light, the second light passing through the second polarizing layer, passing through a first pixel unit of the liquid crystal layer, being incident on the first pixel electrode, being reflected at the first pixel electrode, passing through the first pixel unit, and passing through the second polarizing layer when a potential difference between the first pixel electrode and the opposing electrode is a first voltage, the fourth light passing through the second polarizing layer, passing through the first pixel unit, being incident on the first pixel electrode, being reflected at the first pixel electrode, passing through the first pixel unit, and passing through the second polarizing layer when the potential difference between the first pixel electrode and the opposing electrode is a second voltage, the first pixel unit being provided between the first pixel electrode and the opposing electrode.

5. The device according to claim 4, wherein an effective value of the second voltage is larger than an effective value of the first voltage.

6. The device according to claim 1, further comprising an optical layer provided between the second polarizing layer and the opposing electrode,
an intensity of a scattered light of the optical layer for a light incident on the optical layer from a first incident direction being different from an intensity of a scattered light of the optical layer for a light incident on the optical layer from a second incident direction,
a direction of the first incident direction in a plane parallel to the first major surface being different from a direction of the second incident direction in the plane.

7. The device according to claim 6, wherein
the optical layer includes a plurality of first optical units and a second optical unit, the first optical units being light-transmissive and disposed in the plane, the second optical unit being light-transmissive and provided between two of the first optical units, a refractive index of the second optical unit being different from refractive indexes of the first optical units, and
a boundary between the second optical unit and at least one selected from the first optical units is tilted with respect to the plane.

8. The device according to claim 1, wherein the first pixel electrode and the second pixel electrode have specular reflectivity.

9. The device according to claim 1, wherein
the first substrate unit further includes:
a first substrate provided between the first polarizing layer and the liquid crystal layer, the first substrate being light-transmissive;
a first switching element electrically connected to the first pixel electrode;
a first interconnect electrically connected to the first switching element; and
an insulating layer provided between the first interconnect and the first pixel electrode,
at least a portion of the first interconnect being positioned between the first pixel electrode and the first polarizing layer.

10. The device according to claim 1, wherein an angle between an absorption axis of the first polarizing layer and an absorption axis of the second polarizing layer is not less than 45 degrees and not more than 100 degrees.

11. The device according to claim 1, wherein
the liquid crystal layer includes a first portion on a side of the first substrate unit and a second portion on a side of the second substrate unit, and
an angle between a liquid crystal director direction of the first portion and an absorption axis of the first polarizing layer is not less than 85 degrees and not more than 95 degrees.

12. The device according to claim 11, wherein a twist angle of a liquid crystal director between the first portion and the second portion is not less than 60 degrees and not more than 80 degrees.

13. The device according to claim 1, wherein a product of a thickness (nanometers) of the liquid crystal layer and a refractive index anisotropy of a liquid crystal included in the liquid crystal layer is not less than 180 nanometers and not more than 260 nanometers.

14. The device according to claim 1, further comprising a first phase difference layer provided between the liquid crystal layer and the second polarizing layer,
a retardation of the first phase difference layer being not less than 100 nanometers and not more than 150 nanometers.

15. The device according to claim 14, wherein an angle between a slow axis of the first phase difference layer and an absorption axis of the first polarizing layer is not less than 20 degrees and not more than 40 degrees.

16. The device according to claim 15, further comprising a second phase difference layer provided between the first phase difference layer and the second polarizing layer,
a retardation of the second phase difference layer being not less than 240 nanometers and not more than 290 nanometers.

17. The device according to claim 16, wherein an angle between a slow axis of the second phase difference layer and an absorption axis of the first polarizing layer is not less than 85 degrees and not more than 105 degrees.

18. The device according to claim 1, wherein
the second substrate unit further includes a colored layer, and
the colored layer includes:
a first colored portion overlapping the inter-pixel region when projected onto the first major surface, the first colored portion having a first color; and
a second colored portion overlapping the inter-pixel region and the first colored portion when projected onto the first major surface, the second colored portion having a second color different from the first color.

19. The device according to claim 18, wherein
the colored layer further includes:
a first color filter provided between the first pixel electrode and the second polarizing layer, the first color filter having the first color; and
a second color filter provided between the second pixel electrode and the second polarizing layer, the second color filter having a third color different from the first color.

20. An electronic device, comprising:
a liquid crystal display device; and
an electronic member,
the liquid crystal display device including:
a first polarizing layer;
a second polarizing layer;
a first substrate unit provided between the first polarizing layer and the second polarizing layer, the first substrate unit including a first pixel electrode, a second pixel electrode, and an inter-pixel region between the first pixel electrode and the second pixel electrode, the first pixel electrode and the second pixel electrode being light-reflective and disposed in a first major surface intersecting a direction from the first polarizing layer toward the second polarizing layer;
a second substrate unit provided between the first substrate unit and the second polarizing layer, an opposing electrode being provided in a second major surface of the second substrate unit, the opposing electrode being light-transmissive; and
a liquid crystal layer provided between the first major surface and the second major surface,
at least a portion of a first light passing through the second polarizing layer, the liquid crystal layer, and the inter-pixel region being able to be incident on the first polarizing layer,
the first polarizing layer, the first substrate unit, the liquid crystal layer, and the second substrate unit being disposed between the electronic member and the second polarizing layer,
an intensity of a light emitted from the second polarizing layer being higher than an intensity of a second light, the light emitted from the second polarizing layer being produced when the at least a portion of the first light is incident on the first polarizing layer, is reflected at the electronic member, and passes through the first polarizing layer, the first substrate unit, the liquid crystal layer, and the second substrate unit, the second light passing through the second polarizing layer, passing through a first pixel unit of the liquid crystal layer, being incident on the first pixel electrode, being reflected at the first pixel electrode, passing through the first pixel unit, and passing through the second polarizing layer when a potential difference between the first pixel electrode and the opposing electrode is a first voltage, the first pixel unit being provided between the first pixel electrode and the opposing electrode.
